(19) United States
(12) Patent Application Publication
(10) Pub. No.: US 2005/0064295 A1
(43) Pub. Date: Mar. 24, 2005

(54) Non-aqueous electrolyte battery

(75) Inventors: Masato Iwanaga, Itano-gun (JP); Keisuke Ohga, Itano-gun (JP); Ryuji Ohshita, Tokushima-shi (JP); Masatoshi Takahashi, Itano-gun (JP)

Correspondence Address: NIXON & VANDERHYE, PC, 1100 N GLEBE ROAD, 8TH FLOOR, ARLINGTON, VA, 22201-4714, US

(73) Assignee: Sanyo Electric Co., Ltd., Osaka (JP)

(21) Appl. No.: 10/928,702

(22) Filed: Aug. 30, 2004

(30) Foreign Application Priority Data
Aug. 29, 2003 (JP) 2003-209526

(51) Int. Cl. H01M 10/40

(52) U.S. Cl. 429/330; 429/331

(57) ABSTRACT

A non-aqueous electrolyte battery with improved cyclic characteristics and battery capacity at high temperature and capable of suppressing the evolution of gas during storage at high temperature while maintaining favorable cyclic performance, wherein vinylene carbonate (VC) and α-angelica lactone (4-hydroxy-3-pentenic acid γ-lactone) are contained in the electrolyte, and whereby a highly soft and flexible coating film with α-angelica lactone is formed on the surface of the negative electrode without reducing the initial charging efficiency of the battery. Since a mixed coating film comprising VC and α-angelica lactone is formed on the soft and flexible coating film and the mixed coating film has higher thermal stability at high temperature than that of the coating film formed only with VC, the cyclic characteristics of the battery at high temperature can be improved while enhancing the suppression of gas evolution during storage at high temperature.

### BACKGROUND OF THE INVENTION

1. Field of the Invention

The present invention concerns a non-aqueous electrolyte battery comprising a negative electrode capable of reversibly insertion/extraction lithium, a positive electrode capable of reversibly insertion/extraction lithium at a potential more noble than that of the negative electrode, a separator for separating the positive electrode and the negative electrode, and an electrolyte in which a solute consisting of lithium salt is dissolved in an organic solvent.

2. Description of the Related Art

In recent years, non-aqueous electrolyte batteries typically represented by lithium secondary batteries have been put to practical use as high capacity batteries capable of charging and discharging although small in size and light in weight, and as such have become useful as power supply units for portable electronic and communication equipments such as small-sized video cameras, portable telephones, and book-type personal computers. The lithium secondary battery of the type described above is constituted by using material capable of insertion/extraction lithium ions as a negative electrode active substance, lithium-containing transition metal oxide such as LiCoO₂, LiNiO₂, LiMn₂O₄ and LiFeO₂ capable of insertion/extraction lithium ions as a positive electrode active substance and an electrolyte in which a solution consisting of lithium salt is dissolved in an organic solvent.

In the same lithium secondary battery, the organic solvent used as an ingredient of the electrolyte causes a side reaction on the surface of the material serving as the negative electrode active substance, undesirably affecting the character of the battery. Accordingly, it has become significant to form a film membrane on the surface of the negative electrode so that the negative electrode does not directly react with the organic solvent and to control the forming state and nature of the membrane. To control such a negative electrode surface coating film (SEI: Solid Electrolyte Interface), a technique has been devised whereby a special additive is added to the electrolyte. As a typical additive, vinylene carbonate (VC) which has been described in Japanese Patent Laid-Open Publication No. H08(1996)45545 is added to the electrolyte in which a solution consisting of lithium salt is dissolved in an organic solvent.

Further, in the lithium secondary battery, the decomposition of the organic solvent in the electrolyte during the charging process has the effect of making the capacity of the battery not reversible. This is attributable to electrochemical reduction of the organic solvent when the negative electrode material interfaces with the electrolyte. In Japanese Patent Laid-Open Publication No. H11(1999)-273723, the addition of α-angelica lactone in the electrolyte has been proposed as a means of preventing the decomposition of the organic solvent and thereby provide a lithium secondary battery excellent in cyclic characteristics as well as battery characteristics such as electric capacity and storage characteristic under a charged state.

Further, the organic solvent decomposes at the potential of the negative electrode during charging when cyclic carboxylic acid ester such as γ-butyrolactone and α-angelica lactone as the organic solvent for the electrolyte and carbon material such as graphite as the negative electrode active substance are used, thereby lowering the charging efficiency of the lithium secondary battery. Accordingly, Japanese Patent Laid-Open Publication No. 2001-23684 has proposed the use of a non-aqueous electrolyte formed by adding a cyclic carbonate ester having a carbon-carbon unsaturated bond such as vinylene carbonate to a cyclic carboxylate ester, thereby producing a lithium secondary battery with excellent charging and discharging characteristics under low temperature.

However, as disclosed in the above-mentioned Japanese Patent Laid-Open Publication No. H08(1996)-45545, when vinylene carbonate (VC) is used as an additive to the electrolyte for the lithium secondary battery, while the SEI formed on the surface of the negative electrode has the effect of suppressing the side reaction on the negative electrode as to improve the battery's cyclic characteristics, its initial charging efficiency is lowered since the formed coating film (SEI) is fast, thereby lowering the battery's initial capacity. Further, the use of VC additive in the electrolyte of a lithium secondary battery does not effectively improve the cyclic characteristics of the battery at high temperature and even causes the battery to expand or swell when it is stored at high temperature. It is assumed that when a lithium secondary battery using an electrolyte with VC additive is stored at high temperature, the VC is oxidatively decomposed to evolve carbon dioxide.

On the other hand, the use of α-angelica lactone as an additive to the electrolyte as proposed in the above-mentioned Japanese Patent Laid-Open Publication No. H11(1999)-273723, does not effectively suppress the side reaction on the carbon negative electrode caused by the organic solvent, since the coating film (SEI) formed on the surface of the carbon negative electrode is fragile, and therefore does not contribute to the improvement of the battery's cyclic characteristics.

Further, when cyclic carbonate ester having the carbon-carbon unsaturated bond such as VC is added to cyclic carboxylate ester to form a non-aqueous electrolyte as described in the above-mentioned Japanese Patent Laid-Open Publication No. 2001-23684 as to produce a lithium secondary battery with excellent charging and discharging characteristics under low temperature, use of the cyclic carboxylate ester or VC in great amounts lowers the capacity of the battery by reductive decomposition, thereby adversely affecting the character of the battery due to the formation of an unnecessarily hard and thick negative electrode surface coating film (SEI), and generates as well the evolution of gases due to decomposition of the SEI when the battery is stored at high temperature.

The present invention has therefore been conceptualized to address these problems by providing a non-aqueous electrolyte battery with improved cyclic characteristics and battery capacity at high temperature and capable of suppressing the evolution of gases during storage at high temperature while maintaining the battery's favorable cyclic performance.

### SUMMARY OF THE INVENTION

The aforementioned objective can be attained according to the non-aqueous electrolyte battery of the invention in which vinylene carbonate (VC) and α-angelica lactone (4-hydroxy-3-pentenic acid γ-lactone) are added to the electrolyte, to generate the forming of a highly soft and flexible coating film on the surface of the negative electrode on account of the α-angelica lactone, thereby preventing reduction of the initial charging efficiency of the battery.

Further, a composite coating film consisting of VC and α-angelica lactone is formed on the highly soft and flexible coating film. Since the thermal stability of the mixed composite coating film at high temperature is higher than that of the coating film formed with VC alone, a non-aqueous electrolyte battery with improved cyclic characteristics and battery capacity as well as a stable favorable cyclic performance at high temperature, and capable of suppressing the evolution of gas during storage at high temperature can be obtained.

In this case, it is preferred that the amount of vinylene carbonate (VC) added is 0.5 mass % or more and 3.0 mass % or less depending on the mass of the electrolyte. Further, the amount of α-angelica lactone would preferably be 0.1 mass % or more and 2.0 mass % or less depending on the mass of the electrolyte. The organic solvent is preferably a mixed solvent comprising at least one of ethylene carbonate (EC), dimethyl carbonate (DMC), methylethyl carbonate (MEC) and diethyl carbonate (DEC). It is also preferred that propylene carbonate (PC) is added further to the mixed solvent.

The present invention does not specifically require any type of positive electrode active substance, or negative electrode active substance or non-aqueous electrolyte. Preferably however, the positive electrode active substance should include metal oxides containing at least any one of manganese, cobalt and nickel, or specifically, LiCoO₂, LiNiO₂, LiNi_{0.8}Co_{0.2}O₂ and LiMn₂O₄ while the negative electrode active substance would preferably be comprised of carbon series materials or an alloy series materials. In addition, the specific surface area of the negative electrode active substance would preferably range from 2.0 to 6.0 m²/g.

### BRIEF DESCRIPTION OF THE DRAWINGS

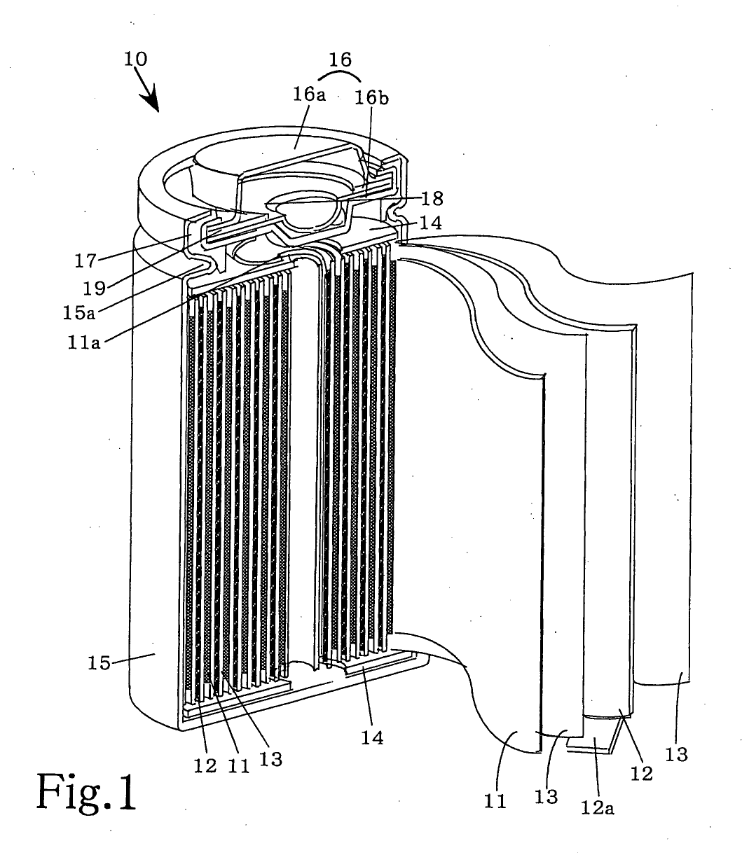

The preferred embodiments of the present invention will hereafter be described in detail based on FIG. 1, which is a partially cut away perspective view schematically showing the main portion of a non-aqueous electrolyte battery according to the present invention shown in the state cut along the longitudinal direction.

### DESCRIPTION OF THE PREFERRED EMBODIMENTS

While the present invention will be described with reference to its preferred embodiments, it is not in any way restricted to such embodiments, which may be modified or changed appropriately without departing from the gist of the invention. FIG. 1 is a partially cut away perspective view, which schematically shows the main portion of a non-aqueous electrolyte battery according to the invention in the state cut along the longitudinal direction.

1. Preparation of the Positive Electrode

To prepare a positive electrode mix, lithium cobaltate (LiCoO₂) powder acting as the positive electrode active substance, acetylene black as a conductive agent and a fluorocarbon resin as binder are mixed at a mass ratio of 90:5:5. N-methyl-2-pyrrolidone (NMP) is then added and mixed to the positive electrode mix to form a slurry, which is thereafter coated on both surfaces of a positive electrode collector made of aluminum foil by means of the doctor blade method to form a positive electrode mix layer. Then, the positive electrode mix layer is dried and rolled to a predetermined packing density and cut into a predetermined shape, thereby making a positive electrode 11. A positive electrode lead 11a is thereafter formed, being extended from one end of the positive electrode 11.

2. Preparation of the Negative Electrode

To prepare a negative electrode mix, graphite (with a specific surface area of about 3.0 m²/g) acting as the negative electrode active substance, carboxymethyl cellulose (CMC) as a viscosity improver and a styrene-butadiene rubber (SBR) as a binder are mixed at a mass ratio of 95:3:2. Water is then added to and mixed with the negative electrode mix to form a slurry, which is thereafter coated on both surfaces of a negative electrode collector made of copper foil by means of the doctor blade method to form a negative electrode active substance layer. Then, the negative electrode active substance layer is dried and rolled to a predetermined packing density and cut into a predetermined shape, thereby making a negative electrode 12. A negative electrode lead 12a is thereafter formed, being extended from one end of the negative electrode 12. For the purpose of investigating the effect of specifying the surface area of the negative electrode active substance, negative electrodes 12 were prepared in the same manner as described above by using graphite, each obtaining a specific surface area of 1.0 m²/g, 2.0 m²/g, 6.0 m²/g and 8.0 m²/g by changing the method of pulverizing the graphite.

In lieu of carboxymethyl cellulose (CMC), methyl cellulose, hydroxymethyl cellulose, ethyl cellulose, polyvinyl alcohol, polyacrylic acid (salt), oxidized starch, phosphated starch, or casein may be used as viscosity improver. Further, instead of styrene-butadiene rubber (SBR), ethylenically unsaturated carboxylic acid esters such as methyl (meth) acrylate, ethyl (meth) acrylate, butyl (meth) acrylate, (meth) acrylonitrile or hydroxyethyl (meth) acrylate may be used as binder. Alternatively, ethylenically unsaturated carboxylic acid such as acrylic acid, methacrylic acid, itaconic acid, fumaric acid or maleic acid may also be used.

3. Preparation of the Electrolyte

An organic electrolyte is prepared by dissolving LiPF₆ in a mixed solvent comprising ethylene carbonate (EC), dimethyl carbonate (DMC) and propylene carbonate (PC) (in terms of volume, EC:DMC:PC=35:60:5) at 1 mol/liter. Predetermined amounts of vinylene carbonate (hereinafter referred to as VC) and α-angelica lactone (4-hydroxy-3-pentenic acid γ-lactone, hereinafter referred to as AGL) are then added to the electrolyte.

In this example, VC with a mass % of 0.5 and AGL with a mass % of 1.0 are added to a prepared organic electrolyte to form an electrolyte a; VC with a mass % of 2.0 and AGL with a mass % of 0.1 are added to a prepared organic electrolyte to form an electrolyte b; VC with a mass % of 2.0 and AGL with a mass % of 0.5 are added to a prepared organic electrolyte to form an electrolyte c. Further, VC with a mass % of 2.0 and AGL with a mass % of 1.0 are added to a prepared organic electrolyte to form an electrolyte d; VC with a mass % of 2.0 and AGL of 2.0 mass % are added to a prepared organic electrolyte to form an electrolyte e, and VC with a mass % of 3.0 and AGL with a mass % of 1.0 are added to a prepared organic electrolyte to form an electrolyte f.

On the other hand, an organic electrolyte is prepared by adding VC with a mass % of 2.0 with no AGL added to form an electrolyte r; an organic electrolyte is prepared by adding VC with a mass % of 2.0 and AGL with a mass % of 0.05 to form an electrolyte s; an organic electrolyte is prepared to which only AGL with a mass % of 0.5 is added to form an electrolyte t. Further, an organic electrolyte is prepared by adding VC with a mass % of 0.3 and AGL with a mass % of 1.0 to form an electrolyte u; an organic electrolyte is prepared by adding VC with a mass % of 2.0 and AGL with a mass % of 3.0 to form an electrolyte v; and finally, an organic electrolyte is prepared by adding VC with a mass % of 4.0 and AGL with a mass % of 1.0 to form an electrolyte w.

Further, an organic electrolyte is prepared by dissolving LiPF₆ in a mixed solvent comprising ethylene carbonate (EC) and dimethyl carbonate (DMC) (in terms of volume, EC:DMC=35:65) at 1 mol/liter, and by adding VC with a mass % of 2.0 and AGL with a mass of 1.0 mass % to form an electrolyte x.

Further, an organic electrolyte is prepared by dissolving LiPF₆ in a mixed solvent comprising ethylene carbonate (EC), dimethyl carbonate (DMC), and propylene carbonate (PC) (in terms of volume, EC:DMC:PC=35:55:10) at 1 mol/liter, and by adding VC with a mass % of 2.0 and AGL with a mass % of 1.0 to form an electrolyte g.

Further, an organic electrolyte is prepared by dissolving LiPF₆ in a mixed solvent comprising ethylene carbonate (EC), dimethyl carbonate (DMC), and propylene carbonate (PC) (in terms of volume, EC:DMC:PC=35:50:15) at 1 mol/liter, and by adding VC with a mass % of 2.0 and AGL with a mass % of 1.0 to form an electrolyte y.

Further, in lieu of LiPF₆, LiBF₄, LiCF₃SO₃, LiAsF₆, LiN(CF₃SO₂)₂, LiC(CF₃SO₂)₃, and LiCF₃(CF₂)₃SO₃, etc. may be used as solute in preparing the organic electrolyte.

4. Preparation of the Non-Aqueous Electrolyte Battery

Having accomplished the above, a spiral electrode group is made by stacking the positive electrode 11 and the negative electrode 12 (using a negative electrode active substance with a specific surface area of 3.0 m²/g) produced in the manner described above, while interposing between them a separator 13 comprising a finely porous polyethylene film and then winding them spirally through a winding machine. Subsequently, after placing insulative plates 14, 14 to the top and bottom portions of the spiral electrode group respectively, the spiral electrode group is inserted into an outside can 15 with a cylindrical bottom made of iron and plated with nickel at the surface thereof, to serve as a negative electrode terminal through the opening thereof. Then, the negative electrode lead 12a made to extend from the negative electrode 12 of the spiral electrode group is welded to the inner bottom surface of the outside can 15. On the other hand, the positive electrode lead 11a made to extend from the positive electrode 11 of the spiral electrode group is welded to the lower surface of a lid 16b of an opening-sealing unit 16.

Then, electrolytes a to g and r to y prepared in the manner described above are charged into the outside can 15, while a cylindrical gasket 17 made of polypropylene (PP) is placed at the opening of the outside can 15 and the opening-sealing unit 16 is inserted into the gasket 17. Then, the upper end of the opening of the outside can 15 is inwardly caulked, and sixteen (16) units of the non-aqueous electrolyte battery 10, each having dimensions of 18 mm in diameter and 65 mm by height (length), and each with a designed capacity of 2000 mAh (A to G, R to Y, Z1 to Z4) are respectively obtained.

The non-aqueous electrolyte battery using the electrolyte a is hereafter referred to as battery A, the non-aqueous electrolyte battery using the electrolyte b is hereafter referred to as battery B, the non-aqueous electrolyte battery using the electrolyte c is hereafter referred to as battery C, the non-aqueous electrolyte battery using the electrolyte d is hereafter referred to as battery D, the non-aqueous electrolyte battery using the electrolyte e is hereafter referred to as battery E, the non-aqueous electrolyte battery using the electrolyte f is hereafter referred to as battery F, the non-aqueous electrolyte battery using the electrolyte g is hereafter referred to as battery G, the non-aqueous electrolyte battery using the electrolyte r is hereafter referred to as battery R, the non-aqueous electrolyte battery using the electrolyte s is hereafter referred to as battery S, the non-aqueous electrolyte battery using the electrolyte t is hereafter referred to as battery T, the non-aqueous electrolyte battery using the electrolyte u is hereafter referred to as battery U, the non-aqueous electrolyte battery using the electrolyte v is hereafter referred to as battery V, the non-aqueous electrolyte battery using the electrolyte w is hereafter referred to as battery W, the non-aqueous electrolyte battery using the electrolyte x is hereafter referred to as battery X, and the non-aqueous electrolyte battery using the electrolyte y is hereafter referred to as battery Y.

Further, a non-aqueous electrolyte battery using the electrolyte d and a negative electrode active substance with a specific surface area of 1.0 m²/g is hereafter referred to as battery Z1, a non-aqueous electrolyte battery using the electrolyte d and a negative electrode active substance with a specific surface area of 2.0 m²/g is hereafter referred to as battery Z2, a non-aqueous electrolyte battery using the electrolyte d and a negative electrode active substance with a specific surface area of 6.0 m²/g is hereafter referred to as battery Z3, and a non-aqueous electrolyte battery using the electrolyte d and a negative electrode active substance with a specific surface area of 8.0 m²/g is hereafter referred to as battery Z4.

The opening-sealing unit 16 is composed of a positive electrode cap 16a as the positive electrode terminal and a lid 16b for sealing the opening of the outside can 15. An elastically deformable conductive plate 18 that deforms when gas pressure in the battery increases to a predetermined set level (for example, 14 MPa) and a PTC (Positive Temperature Coefficient) element 19 whose resistance value increases when a temperature rise occurs in the opening-sealing unit 16 comprising the positive electrode cap 16a and the lid 16b. Then, when excess current flows in the battery causing the abnormal generation of heat, the resistance value of the PTC element 19 increases, thereby minimizing the excess current. In addition, when the increase in gas pressure in the battery is higher than a predetermined set level (for example 14 MPa), the elastically deformable conductive plate 18 deforms to break its contact with the lid 16b in order to shut the excess current or short circuit current.

5. Battery Test

(1) Measurement of Initial Capacity

Each of the batteries A, B, C, D, E, F, G, R, S, T, U, V, W, X, Y, Z1, Z2, Z3 and Z4 was respectively set at room temperature (about 25° C.) and put to constant-current charging at a charging current of 2000 mA (1 It) until the battery voltage thereof reached 4.2 V and thereafter put to constant-voltage charging at a constant voltage of 4.2 V until the current value reached 40 mA. Then, each battery was discharged at a discharging current of 2000 mA (1 It) until the battery voltage thereof dropped to 2.75 V. The initial discharge capacity was determined by measuring the discharge capacity based on discharge time. The results obtained are shown in the following Tables 1 and 2.

(2) High Temperature Cyclic Characteristic Test

Each of the batteries A, B, C, D, E, F, G, R, S, T, U, V, W, X, Y, Z1, Z2, Z3 and Z4 was respectively set at an atmospheric temperature of 40° C. and put to constant-current charging at a charging current of 2000 mA (1 It) until the battery voltage reached thereof 4.2V and thereafter put to constant-voltage charging at a constant voltage of 4.2 V until the current value reached 40 mA. Then, each battery was discharged at a discharging current of 2000 mA (1 It) until the battery voltage thereof dropped to 2.75 V. Three hundred (300) of such charging and discharging cycles was conducted for each battery and the residual discharge capacity (mAh) after 300 cycles was determined. Thereafter, the percentage ratio between the initial discharge capacity and the residual discharge capacity after 300 cycles was determined thereby establishing the high temperature cyclic characteristics (capacity maintaining ratio after 300 cycles). The results obtained are shown in Tables 1 and 2.

(3) Low Temperature Charging Characteristic Test

Further, each of the batteries A, B, C, D, E, F, G, R, S, T, U, V, W, X, Y, Z1, Z2, Z3 and Z4 was respectively set at room temperature (about 25° C.) and put to constant-current charging at a charging current of 2000 mA (1 It) until the battery voltage thereof reached 4.2 V and then put to constant-voltage charging at a constant voltage of 4.2 V until the current value reached 40 mA. Thereafter, each battery was discharged at a discharging current of 2000 mA (1 It) until the battery voltage thereof dropped to 2.75V. At the second cycle, each battery was respectively set at room temperature (about 25° C.) and put to constant-current charging at a charging current of 2000 mA (1 It) until the battery voltage thereof reached 4.2 V and then put to constant-voltage charging at a constant voltage of 4.2 V until the current value reached 40 mA. To determine the discharge capacity (mAh), each battery was then cooled to −20° C. and discharged at a discharging current of 2000 mA (1 It) until the battery voltage thereof dropped to 2.75V. Then, the capacity maintenance ratio was established by determining the percentage ratio between the initial discharge capacity and the discharge capacity at the second cycle and thereafter, the average operational voltage (V) of each battery at the second cycle was determined. The results obtained are shown in Tables 1 and 2.

(4) Measurement of the Amount of Gas Evolved During Storage at High Temperature

Further, each of the batteries A, B, C, D, E, F, G, R, S, T, V was respectively set at room temperature (about 25° C.) and put to constant-current charging at a charging current of 2000 mA until the battery voltage thereof reached 4.2 V and then put to constant-voltage charging at a constant voltage of 4.2 V until the current value reached 40 mA. At this point, each of batteries A, B, C, D, E, F, G, R, S, T and V was charged fully and after complete charging, was stored in an atmospheric temperature of 60° C. for 20 days and thereafter, the amount of gas evolved in each of the batteries A, B, C, D, E, F, G, R, S, T and V was measured. The results obtained are shown in Table 1.

TABLE 1

| | Composition | Additive | | | | Discharge | | Amount |
|---|---|---|---|---|---|---|---|---|
| | of | to | | | Cyclic | Characteristics | | of Gas |
| Type | Electrolyte: | Electrolyte | | Initial | Characteristic | at low temperature | | after |
| of | solute/ | VC | AGL | Capacity | at high | Capa | Operation | storage |
| Battery | solvent | (wt %) | (wt %) | (mAh) | temperature | city ratio | voltage | (ml) |
| R | 1M LiPF₆ | 2.0 | 0 | 2070 | 58% | 68% | 3.12 V | 6.2 |
| S | EC/DMC/ | 2.0 | 0.05 | 2070 | 59% | 67% | 3.11 V | 6.0 |
| T | PC = | 0 | 0.5 | 2088 | 52% | 67% | 3.11 V | 5.5 |
| U | 35/60/5 | 0.3 | 1.0 | 2085 | 53% | 69% | 3.11 V | |
| A | | 0.5 | 1.0 | 2100 | 72% | 68% | 3.10 V | 3.5 |
| B | | 2.0 | 0.1 | 2098 | 75% | 69% | 3.12 V | 3.4 |
| C | | 2.0 | 0.5 | 2102 | 81% | 70% | 3.11 V | 2.7 |
| D | | 2.0 | 1.0 | 2108 | 83% | 67% | 3.11 V | 2.5 |
| E | | 2.0 | 2.0 | 2110 | 84% | 65% | 3.12 V | 2.2 |
| F | | 3.0 | 1.0 | 2105 | 86% | 65% | 3.10 V | 2.8 |
| V | | 2.0 | 3.0 | 2100 | 87% | 59% | 3.07 V | 2.5 |
| W | | 4.0 | 1.0 | 2098 | 87% | 62% | 3.05 V | |
| X | 1M LiPF₆ | 2.0 | 1.0 | 2073 | 66% | | | |
| | EC/DMC = | | | | | | | |
| | 35/65 | | | | | | | |
| G | 1M LiPF₆ | 2.0 | 1.0 | 2100 | 81% | | | |
| | EC/DMC/ | | | | | | | |
| | PC = | | | | | | | |
| | 35/55/10 | | | | | | | |
| Y | 1M LiPF₆ | 2.0 | 1.0 | 2078 | 68% | | | |
| | EC/DMC/ | | | | | | | |
| | PC = | | | | | | | |
| | 35/50/15 | | | | | | | |

TABLE 2

| | Negative | | | | | | | |
|---|---|---|---|---|---|---|---|---|
| | Electrode | Composition | | | | | Discharge | |
| | Specific | of | Additive | | | Cyclic | Characteristics | |
| Type | Surface | Electrolyte: | to | | Initial | Characteristics | at low temperature | |
| of | Area | solute/ | Electrolyte | | Capacity | at high | Capacity | Operation |
| battery | (m²/g) | solvent | VC | AGL | (mAh) | temperature | Ratio | Voltage |
| Z1 | 1.0 | 1M LiPF₆ | 2.0 | 1.0 | 2081 | 70% | 53% | 3.05 V |
| Z2 | 2.0 | EC/DMC/ | 2.0 | 1.0 | 2105 | 83% | 67% | 3.11 V |
| D | 3.0 | PC = | 2.0 | 1.0 | 2108 | 83% | 67% | 3.11 V |
| Z3 | 6.0 | 35/60/5 | 2.0 | 1.0 | 2113 | 85% | 70% | 3.12 V |
| Z4 | 8.0 | | 2.0 | 1.0 | 2111 | 55% | 63% | 3.08 V |

As shown in Table 1, the battery R using the electrolyte r to which only VC was added to a mixed solvent comprising ethylene carbonate (EC), dimethyl carbonate (DMC) and propylene carbonate (PC) (EC:DMC:PC=35:60:5) exhibited low initial capacity and low cyclic characteristics (capacity maintenance ratio after 300 cycles) at high temperature and evolved a great amount of gas after being stored at 60° C. for 20 days.

This is attributable to the fact that when VC is the only additive to the electrolyte used, the coating layer formed on the surface of the carbon negative electrode (SEI) is fast, and, accordingly, the initial charging efficiency of the battery diminishes, thereby reducing initial capacity. Further, it is believed that when the battery using such electrolyte merely containing VC as additive is stored at high temperature, the VC is oxidatively decomposed as to evolve carbonic gases, such that the capacity maintenance ratio after 300 cycles (cyclic characteristics at high temperature) is reduced, thereby increasing the amount of gas evolved after storage at 60° C. for 20 days.

Further, it can likewise be seen that the battery T using the electrolyte t to which only α-angelica lactone (AGL) was added to the mixed solvent with the same composition described above (EC:DMC:PC=35:60:5) also exhibited small initial capacity and low cyclic characteristics (capacity maintenance ratio after 300 cycles) at high temperature and evolved a great amount of gas after being stored at 60° C. for 20 days. It is believed that when AGL is the only additive to the electrolyte, the coating film formed on the surface of the carbon negative electrode (SEI) is weak, such that suppression of side reactions on the carbon negative electrode in relation to the organic solvent becomes difficult to achieve, thereby lowering the initial charging efficiency of the battery, ultimately reducing its initial capacity.

On the contrary, it can be seen that the batteries A, B, C, D, E, F and V respectively using the electrolytes a, b, c, d, e, f and v with VC and AGL added to the mixed solvent with the same composition described above (EC:DMC:PC=35:60:5) showed high initial capacity and high cyclic characteristics (capacity maintenance ratio after 300 cycles) at high temperature and evolved less amount of gas after being stored at 60° C. after 20 days.

It is believed that when both VC and AGL are added to the electrolyte, a highly soft and flexible coating film with AGL is formed on the surface of the negative electrode which does not have the effect of lowering the initial charging efficiency, such that the initial capacity of the battery is improved. Further, since the mixed coating film comprising VC and AGL that is formed on the soft and flexible coating film has higher thermal stability at high temperature than the coating film formed only with VC, the cyclic characteristics of the battery as well as the level of suppression of gas evolving during storage at high temperature could also be improved.

In this case, since the discharge characteristics exhibited by the battery V using the electrolyte v with AGL as additive in the amount of 3.0 mass % (capacity maintenance ratio and the average operation voltage after 300 cycles at −20° C.) at low temperature are low, the amount of AGL added should preferably be limited to 2.0 mass % or less based on the mass of the electrolyte. Further, if the amount of AGL added is insufficient, there would be insignificant improvement in the initial capacity and cyclic characteristics of the battery at high temperature, and the suppression of gas evolving when the battery is stored at high temperature can not be sufficiently effected. Therefore, the amount of AGL added should preferably be limited to 0.1 mass % or more based on the mass of the electrolyte.

Further, since the discharge characteristics (capacity maintenance ratio and average operation voltage after 300 cycles at −20° C.) at low temperature are comparatively low when the amount of VC added is more than 3.0 mass % while the cyclic characteristic (capacity maintenance ratio after 300 cycles) at high temperature is likewise low when the amount of VC added is less than 0.5 mass %, the amount of VC added should preferably be limited to 0.5 mass % or more and 3.0 mass % or less based on the mass of the electrolyte.

Further, when the batteries X, C, F, and Y are compared, where the amount of propylene carbonate (PC) added to the electrolyte is less than 5 mass %, the initial capacity of the battery is not improved, and if it exceeds 10 mass %, the initial capacity is conversely lowered such that the cyclic characteristic (capacity maintenance ratio after 300 cycles) at high temperature is consequently reduced. Accordingly, it is desirable to limit the amount of propylene carbonate (PC) added to 5 mass % or more and 10 mass % or less.

Further, it can be deduced from the results shown in Table 2 that in the case of the batteries D, Z1, Z2, Z3 and Z4, the initial capacity and cyclic characteristics of the battery are comparatively low if the specific surface area of the negative electrode active substance is less than 2.0 m²/g, and where the specific surface area is more than 6.0 m²/g, the cyclic characteristics of the battery are likewise relatively low. It is therefore reasonable to conclude that when the specific surface area of the negative electrode active substance is small, the VC and AGL which are not utilized in the formation of the coating film actually remain in great amounts in the electrolyte even after the formation of the coating film with VC and AGL on the negative electrode, while on the other hand, no sufficient coating film is formed when the specific surface area of the negative electrode active substance is large. Accordingly, the specific surface area of the negative electrode active substance should preferably range from 2.0 to 6.0 m²/g.

As has been described above, since vinylene carbonate (VC) and α-angelica lactone (4-hydroxy-3-pentenic acid γ-lactone) are added in the electrolyte in the non-aqueous electrolyte battery 10 of the invention, a highly soft and flexible coating film with α-angelica lactone is formed on the surface of the negative electrode 12 which does not have the effect of reducing the initial charging efficiency of the battery. Further, since a mixed coating film comprising VC and α-angelica lactone is formed on the highly soft and flexible coating film and the mixed coating film has higher thermal stability at high temperature than the coating film formed with VC alone, the cyclic characteristic of the battery improves at high temperature and suppression of the gas evolving during storage at high temperature is likewise enhanced.

1. A non-aqueous electrolyte battery comprising a negative electrode capable of reversibly insertion/extraction lithium, a positive electrode capable of reversibly insertion/extraction lithium at a potential more noble than that of the negative electrode, a separator for separating the positive electrode and the negative electrode and an electrolyte in which a solute consisting of lithium salt is dissolved in an organic solvent, wherein
vinylene carbonate and α-angelica lactone (4-hydroxy-3-pentenic acid γ-lactone) are contained in the electrolyte,
the amount of vinylene carbonate added is from 0.5 to 3.0 mass % based on the mass of the electrolyte, and
the amount of α-angelica lactone added is from 0.1 to 2.0 mass % based on the mass of the electrolyte.

2. A non-aqueous electrolyte battery according to claim 1, wherein propylene carbonate is added 5 to 10% in terms of volume to the organic solvent.

3. A non-aqueous electrolyte battery according to claim 1, wherein the specific surface area of the negative electrode active substance ranges from 2.0 to 6.0 m²/g.

4. A non-aqueous electrolyte battery according to claim 1, wherein propylene carbonate (PC) is added 5 to 10% in terms of volume to the organic solvent and the specific surface area of the negative electrode active substance ranges from 2.0 to 6.0 m²/g.
